(19) United States
(12) Patent Application Publication
(10) Pub. No.: US 2014/0037575 A1
(43) Pub. Date: Feb. 6, 2014

(54) Wild Game drops

(71) Applicants: Cheryl Lynn Mitchell, (US); Robert Glenn Mitchell, (US)

(72) Inventors: Cheryl Lynn Mitchell, (US); Robert Glenn Mitchell, (US)

(21) Appl. No.: 13/475,954

(22) Filed: Aug. 6, 2012

(51) Int. Cl. A01N 25/24; A01P 19/00

(52) U.S. Cl. 424/84

(57) ABSTRACT

Wild Game Drops is a soy wax drop impregnated with game animal liquid urine or fragrance oil. These drops are 100% biodegradable, non-toxic, environmentally safe and made from 100% dehydrogenated soy oil. The drops are used by a “hunter” as a wild game animal attractant or lure. The Wax is poured into a mold, frozen and released then bagged into individual bags for a no mess application. The drops can be placed anytime during the hunting process to allow the urine or fragrance oil to permeate into the air. The drops do not have to be melted as they will slowly release the scent as the day warms. Animals are attracted to the soy wax drops due to the different types of urine or fragrance oil used.

A process and material used for attracting game animals primarily for hunting (gun, bow, camera, etc.). The material is a wax base impregnated with liquid animal urine, estrogen, and fragrance oils. The main wax that is used is 100% soybean oil that is a natural wax, biodegradable, non-toxic, and environmentally safe. The wax is melted then the aromatic fragrances are added and then poured into a small mold.

### FIELD OF THE INVENTION

The invention relates to a game animal attractant composition, as well as the method of making and using the composition.

### BACKGROUND OF THE INVENTION

Hunting game animals has become a science and an art form. Animals rely heavily on their sense of smell and have the ability to sense danger, food, other animals, humans and most importantly a potential mate. Due to this highly developed sense of smell hunters have found it necessary to blend into their environment so that the game animals will not be alerted to his presence. It is also necessary to use products to bring an animal to the hunter.

People have used many different methods to attract game animals. Most will use a male oriented lure to bring larger dominant game animals into their shooting lanes. Generally those attractants used are either placed on or in a non-biodegradable object to disburse the fluid or scent. The fluid attractant is poured on some type of pad or cotton rag to make a mock scrape of some form or hung on a bush, tree or higher elevated object. The hunters have to go back to the places they placed the ground objects and hanging objects to remove them. Several problems arise from this process, using the fluids may become very messy and inconvenient. If spilled, the extremely aromatic fluids can leave pungent smells on the hunter's skin or clothing. During the main hunting seasons the areas may be at freezing temperatures and the fluids or cotton rags, pads or gels may freeze. Or during the heated days the fluids may evaporate quickly.

A number of inventions have been developed over the years coming up with new and better ways to disburse the fluids in specific locations. The following US patents are samples of a few of those inventions.
U.S. Pat. No. 6,685,929 discloses a viscous, non-liquid, non-gel scent lure for hunting, consisting of animal urine and a thickening agent. The thickening agent may comprise about 1% to about 7% by weight. The resulting viscosity of the solution ranges from about 1500 to about 10,000 centipoise.
U.S. Pat. No. 5,916,552 discloses, a semi-solid deer attractant lure comprised of liquid deer urine plus a sufficient amount of flavorless gelatin to produce a semi-solid rubbery composition is disclosed. Also disclosed is a method of making and a method of using the deer attractant lure composition.
U.S. Pat. No. 6,991,784 discloses the present invention is a lure optimized for a particular animal such as deer. The optimized lure is made using urine from only two animals urinating at approximately the same time. The animals can be either male or female, but preferably, females in estrus are used for optimal results. This mixture of urine is not diluted in any manner with that of additional animals or preservatives. The urine for the lure is obtained by using a single stall exclusively for only two animals for the purpose of gathering urine. This technique has been especially effective in attracting wandering bucks in rut.
U.S. Pat. No. 6,506,395 discloses the present invention is directed to a wildlife attractant comprised of an extract from the fruit of the hedge apple tree and methods for using the attractant to attract deer and cover the scent of a human user.
U.S. Pat. No 4,990,514, describes an insecticide bait that contains some Knox Brand Gelatin, plus numerous other components. Inazuka et al, in U.S. Pat. No. 4,160,824 discloses an insect attracting composition that contains gelatin plus numerous other components. Gelatin as one component for insect bait is disclosed by Hennart et al. in U.S. Pat. No. 4,205,066 and by Nesbitt et al in U.S. Pat. No. 4,487,759.
U.S. Pat. No. 5,327,667 discloses an absorbent pad with brittle container of scent fluid attached. The device is secured to a hunter's boot or clothing and the container ruptured to disperse the scent.
U.S. Pat. No. 5,429,271 discloses a device that warms a liquid lure to disperse the scent in cold temperature conditions.
U.S. Pat. No. 5,465,521, discloses a container with scent cartridges that a hunter may suspend from a branch to disperse scent at a hunting site.

At this time there exists an unmet need for a wild game animal attractant material that produces a potent scent, biodegradable, can be taken to remote areas, and does not have to be removed after use and is environmentally friendly.

### SUMMARY OF INVENTION

The invention is a solid wax based game animal attractant lure comprising of animal urine and a sufficient amount of wax to produce a solid biodegradable composition. The invention also includes a method making cover scent products with fragrance oils and a sufficient amount of wax to produce a solid biodegradable composition. The steps include heating wax to 175 degrees F. then mixing in the urine, estrogen or fragrance oils into the said wax then letting the mixture cool to approximately 105 degrees F. to pour into a mold and packaged into a food grade heat sealed airtight bag for freshness. Also disclosed is a method of using the wax attractant lure. The steps include obtaining a solid biodegradable game animal attractant lure composed of wax and urine, estrogen, or fragrance oils opening the heat sealed bag and dropping or rubbing into the environment so the wind will pick up the fragrance and attract/lure game animals to the site.

### DESCRIPTION OF THE PREFERRED EMBODIMENTS

During the hunting seasons, animal attractants and lures are primarily used to bring prime animals to a selected site chosen by a hunter. These attractants and lures are usually liquid and are placed either directly onto the ground or onto some form of apparatus to disburse scent.

The said invention is a game animal attractant lure composition, as well as a method of making and using the composition.

The composition is wax impregnated with a sufficient amount of animal urine, estrogen and fragrance oils. The Ratio of urine, estrogen and fragrance oils depends on the strength desired. Lower strength: the urine, estrogen and fragrance oils are used at 3% per 1 pound of wax up to a stronger scent at 7-9% per 1 pound of wax. The main wax that is used is 100% soybean oil that is a natural wax, biodegradable, non-toxic, and environmentally safe. You can also use beeswax, palm oil wax, paraffin wax, or a blend of said waxes. The wax is heated to 175 degrees F. then mixing room temperature urine, estrogen or fragrance oil and allowing cooling to 105 degree F. For the urine and estrogen a 5% emulsifying wax is added for full emulsion. The tray is covered in a mold release spray for easy removal. Then pouring the wax mixture into small mold trays and then freezing to release. Allowing cooling to 105 degrees F. the fragrance and wax emulsify and take to the mold. The wax drops are then placed in a heat sealed food grade bag for freshness until needed.

Animal urine, estrogen and fragrance oils are available through commercial game farms offered in small bottles from 2 oz-6 oz. Soy wax and other waxes are available through commercial candle suppliers along with the fragrance oils.

Once the wax drops are packaged in air tight bags, it is recommended that the product be kept refrigerated to help maintain their freshness and form.

Also disclosed is a method of using the solid wax based game animal attractant lure or cover. The steps include:
1. Obtaining a solid wax based game animal attractant lure composed of animal urine, estrogen, or fragrance oils.
2. Opening the bag and placing the contents whole or crushed onto the ground or rubbing the contents onto something elevated to attract game animals.
3. The solid wax based game animal attractant lure or cover will emit the aroma as the animal paws at it or ground into the dirt, leaves, or as the day warms. These can be used in cold climates due to the level of fragrance they do not have to be melted to release scent or aroma.

While the invention has been primarily manufactured in 100% soy bean oil it will be understood that those skilled in the art that various changes in form and details may be made therein without departing from the spirit and scope of the invention.

I claim:

1. A wax based game animal attractant lure composition comprising:
a. A game animal attractant lure using “liquid” animal urine, estrogen and fragrance oils; and
b. Soy “wax” (but can also use other biodegradable waxes) having a medium consistency, wherein the weight ratio of said liquid to said “wax” is from 3% for lower fragrance to 7% per 1 lbs of “wax” for strong scent.

2. The composition according to claim 1, wherein said liquid urine, and estrogen are from female and male game animals.

3. A method of attracting game animals comprising:
a. Placing said game animal attractant lure composition in scrapes, or use as a rub on trees, rocks, or anyplace a game animal is located.
